(19) United States
(12) Patent Application Publication
(10) Pub. No.: US 2011/0273405 A1
(43) Pub. Date: Nov. 10, 2011

(54) TOUCH SCREEN DEVICE

(75) Inventors: Yeon Ho SON, Gyunggi-do (KR); Dae Woong Yun, Incheon (KR); Ji Yeoun Jang, Gyunggi-do (KR); Ki Suk Woo, Seoul (KR); Kum Kyung Lee, Gyunggi-do (KR); Dong Sun Park, Seoul (KR); Jae Kyung Kim, Gyunggi-do (KR); Su Young Jung, Gyunggi-do (KR)

(73) Assignee: SAMSUNG ELECTRO-MECHANICS CO., LTD., Gyunggi-do (KR)

(21) Appl. No.: 12/940,956

(22) Filed: Nov. 5, 2010

(30) Foreign Application Priority Data
May 4, 2010 (KR) 10-2010-0042046

(51) Int. Cl. G06F 3/043

(52) U.S. Cl. 345/177

(57) ABSTRACT

Disclosed herein is a touch screen device, including: a case that partitions an internal space, a touch panel module that is received in the case to recognize external pressure, a first actuator that is mounted at the lower part of the touch panel module to generate vibration, a second actuator that is mounted at the case to generate vibration, and
a coupling member that is provided between the case and the touch panel module, wherein the vibration direction of the first actuator is different from that of the second actuator.

### CROSS REFERENCE TO RELATED APPLICATION

This application claims the benefit of Korean Patent Application No. 10-2010-0042046, filed on May 4, 2010, entitled “Touch Screen Device”, which is hereby incorporated by reference in its entirety into this application.

### BACKGROUND OF THE INVENTION

1. Technical Field

The present invention relates to a touch screen device.

2. Description of the Related Art

With the recent users' demands for simply using electronic products, a touch screen that inputs instructions by touching the electronic product has been widely used. Besides inputting instructions by touching the electronic product, the touch screen device reflects users' intuitive experiences using an interface with more diverse feedbacks.

The touch screen device has various advantages of being very compatible with IT devices in addition to being simply operated in a small space, easily changing its specification, and high in user recognition. Owing to these advantages, the touch screen device is widely used in various fields such as industry, traffic, service, medicine, mobile, and the like.

As shown in FIG. 3, a touch screen device 10 according to the prior art includes a touch screen panel 12 that is mounted on the upper part of a main body 11 and a vibrator 13 that is mounted at the inner side part of the main body 11.

The touch screen panel 12 is a part to which a user's touch pressure is applied, and the vibrator 13 is a device that is mounted at the inner side part of the main body 11 to generate vibration, wherein a piezo actuator or a linear motor is used.

The vibrator 13 is mounted at the inner side part of the main body 11, such that when a user touches the upper part of the touch screen panel 12, vibration is transferred well to the main body 11 but is not transferred relatively well to the touch screen panel 12.

In order to solve the above problem, it is most preferable to directly mount the vibrator 13 on the touch screen panel 12 attached with an LCD. However, it is difficult to directly mount the existing vibrator thereon due to the large size.

Therefore, the touch screen panel 12 is to be directly vibrated by mounting an ultra-thin actuator using a piezo. The piezo mounted on the touch screen 12, however, vibrates the touch screen panel 12, while being vibrated up and down, thereby limiting implementation of various feedbacks.

Therefore, there is an urgent demand for a study on a touch screen device capable of implementing various sensations (or directions) of vibrations.

### SUMMARY OF THE INVENTION

The present invention has been made in an effort to provide a touch screen device capable of implementing various sensations of vibrations.

A touch screen device according to a preferred embodiment of the present invention includes: a case that partitions an internal space; a touch panel module that is received in the case to recognize external pressure; a first actuator that is mounted at the lower part of the touch panel module to generate vibration; a second actuator that is mounted at the case to generate vibration; and a coupling member that is provided between the case and the touch panel module, wherein the vibration direction of the first actuator is different from that of the second actuator.

Herein, the touch panel module is configured to include a touch screen panel and an image display unit that is mounted at the lower part of the touch screen panel.

Further, the touch panel module is formed by integrating the touch screen panel with the image display unit.

Further, the first actuator generates vibration in a vertical direction to the longitudinal direction of the touch panel module.

Further, the second actuator generates vibration in a horizontal direction to the longitudinal direction of the touch panel module.

Further, the first actuator is a piezo or polymer actuator.

Further, the second actuator is a linear motor.

Further, the coupling member is rubber or double-sided tape.

### BRIEF DESCRIPTION OF THE DRAWINGS

FIG. 1 is an exploded perspective view of a touch screen device according to a preferred embodiment of the present invention;

FIG. 2 is a cross-sectional view of a touch screen device according to a preferred embodiment of the present invention; and

FIG. 3 is a cross-sectional view of a touch screen device according to the prior art.

### DESCRIPTION OF THE PREFERRED EMBODIMENTS

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

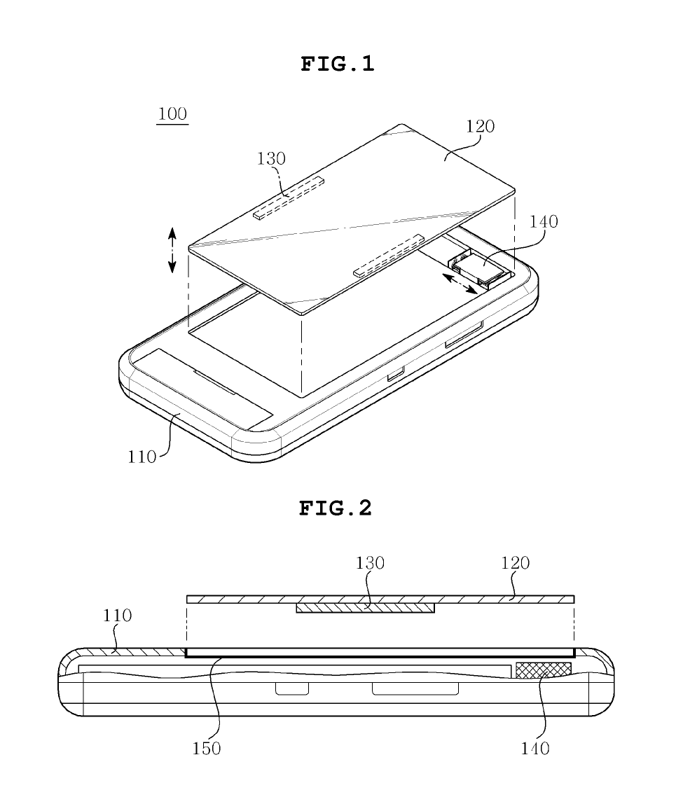

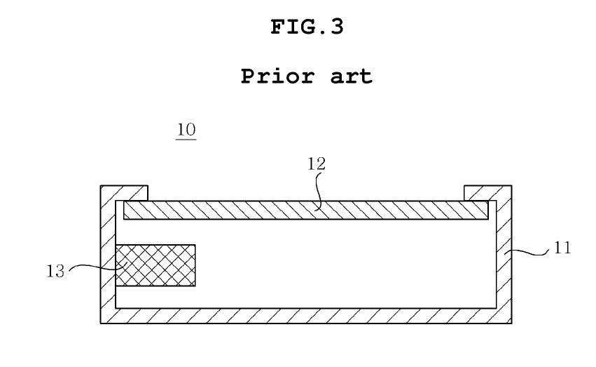

FIGS. 1 and 2 show a touch screen device 100 according to a preferred embodiment of the present invention. The touch screen device 100 includes a case 110, a touch panel module 120, a first actuator 130, a second actuator 140, and a coupling member 150.

The case 110 partitions an internal space and surrounds and supports the touch screen device 100 to protect it from external impact.

The touch panel module 120 is received in the case 110 (or provided on the upper part) and represents a touch screen panel (not shown) and an image display unit (not shown) mounted at the lower part thereof, wherein the touch screen panel has transparency and flexibility and functions as an input signal surface that needs to be pressed in order to operate, while seeing the image displayed on the image display unit mounted at the lower part thereof.

The touch screen panel is formed, for example, by stacking an external film layer, an ITO film layer, and a base film layer.

Herein, the external film layer is mounted on the front surface part of a mobile communication terminal and may be divided into a viewing area where a touch input is available and a dead space area formed on the peripheral of the viewing area. Meanwhile, the external film layer is made of a transparent film material, for example, such as poly ethylene terephtalate (PET), in order to see through a screen on the image display unit.

Even though the indium tin oxide (ITO) film layer is not shown in detail, two upper and lower film layers are stacked and a dot spacer to keep the interval therebetween constant is provided therebetween. An electrode film in which conductive X-axis pattern and Y-axis pattern are formed along an edge is provided on each film layer, wherein the X-axis pattern and the Y-axis pattern is electrically separate by an insulator (not shown). The electrode film is exposed to the outside of the ITO film layer through an FPC cable so as to be electrically connected to a portable terminal.

The base film layer serves to support the entire touch panel. The base film layer may use, for example, a glass substrate having excellent transmittance and touch response speed.

The image display unit mounted at the lower part of the touch screen panel is a device that changes and transfers various electrical information generated from various device into visual information by using change in transmittance of liquid crystals depending on the applied voltage. The image display unit is formed of one or more layers.

The touch screen panel may be formed to be integral with the image display unit. The integrated structure has higher productivity as compared to a separated structure, having high strength against impact.

The first actuator 130 is an actuator that is mounted at the lower part of the touch panel module 120 and is contracted or expanded due to external power to apply vibratory sensation, while simultaneously being slimmed in thickness. The first actuator 130 generates vibration in a vertical direction to a longitudinal direction of the touch panel module 120, and preferably, a piezo (or polymer) actuator may be used.

The first actuator 130 has no limitation in the shape and the size but is generally provided to have a thin rod shape. The first actuator 130 has no limitation in mounted positions but is generally mounted at the central lower part of the touch panel module 120 so as to apply maximum vibratory sensation to a user.

In addition, the first actuator 130 may also be provided in a single or in plural according to the type of touch screen device 100.

The second actuator 140 is a device that is mounted at a partial surface of an inner side of the case 110 to generate vibration. The second actuator 140 generates vibration in a horizontal direction to a longitudinal direction of the touch panel module 120, to the contrary of the first actuator 130 generating vibration in the vertical direction. Herein, as the second actuator, a device capable of generating vibration in the horizontal direction, such as a linear motor, is used.

The second actuator 140 has no limitation in the shape and the size and may be variously provided according to the type of touch screen device 100 and the vibratory force required therefor.

As described above, the first actuator 130 that generates vibration in the vertical direction is mounted at the lower part of the touch panel module 120 and the second actuator 140 that generates vibration in the horizontal direction is mounted at the inside of the case 110, such that a user can feel various vibrations at the time of touch, that is, simultaneous vertical and horizontal vibrations.

Herein, the positions of the first actuator 130 and the second actuator 140 may be changed to be mounted. At this time, the second actuator 140 is mounted at the lower part of the touch panel module 120 and the first actuator 130 is mounted at the inside of the case 110. In this case, the vibration in the horizontal direction is applied to the touch panel module 120, whereas the vibration in the vertical direction is applied to the case 110.

The coupling member 150 is provided between the case 110 and the touch panel module 120. The coupling member 150 more clearly distinguishes the vibration direction of the touch panel module 120 from the vibration direction of the case 110, such that a user can feel various vibrations.

The coupling member 150 may use an elastic member such as rubber or an adhesive member such as double-sided tape.

The touch screen device 100 having the characteristics described above includes the first actuator 130 mounted at the touch panel module 120 and generating the vibration in the vertical direction and the second actuator 140 mounted at the inside of the case 110 and generating the vibration in the horizontal direction, such that a user can feel various vibratory sensations when he or she touches the module.

According to the present invention, the touch screen device includes the first actuator mounted at the touch panel module and generating the vibration in the vertical direction and the second actuator mounted at the inside of the case and generating the vibration in the horizontal direction, such that a user can feel various vibrations when he or she touches the module.

Although the preferred embodiments of the present invention have been disclosed for illustrative purposes, they are for specifically explaining the present invention and thus the touch screen device according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A touch screen device, comprising:
a case that partitions an internal space;
a touch panel module that is received in the case to recognize external pressure;
a first actuator that is mounted at the lower part of the touch panel module to generate vibration;
a second actuator that is mounted at the case to generate vibration; and
a coupling member that is provided between the case and the touch panel module,
wherein the vibration direction of the first actuator is different from that of the second actuator.

2. The touch screen device as set forth in claim 1, wherein the touch panel module is configured to include a touch screen panel and an image display unit that is mounted at the lower part of the touch screen panel.

3. The touch screen device as set forth in claim 1, wherein the touch panel module is formed by integrating the touch screen panel with the image display unit.

4. The touch screen device as set forth in claim 1, wherein the first actuator generates vibration in a vertical direction to the longitudinal direction of the touch panel module.

5. The touch screen device as set forth in claim 1, wherein the second actuator generates vibration in a horizontal direction to the longitudinal direction of the touch panel module.

6. The touch screen device as set forth in claim 1, wherein the first actuator is a piezo or polymer actuator.

7. The touch screen device as set forth in claim 1, wherein the second actuator is a linear motor.

8. The touch screen device as set forth in claim 1, wherein the coupling member is rubber or double-sided tape.
